(19) United States
(12) Patent Application Publication
(10) Pub. No.: US 2026/0154004 A1
(43) Pub. Date: Jun. 4, 2026

(54) METHOD AND DEVICE FOR CONTROLLING MULTIPLE NEURAL PROCESSING UNITS

(71) Applicant: SAMSUNG ELECTRONICS CO., LTD., Suwon-si (KR)

(72) Inventors: Seungsu SHIN, Suwon-si (KR); Sola LEE, Suwon-si (KR); Joonyoung LEE, Suwon-si (KR); Seungwon HA, Suwon-si (KR); Chanyoung HWANG, Suwon-si (KR)

(73) Assignee: SAMSUNG ELECTRONICS CO., LTD., Suwon-si (KR)

(21) Appl. No.: 19/298,794

(22) Filed: Aug. 13, 2025

Related U.S. Application Data
(63) Continuation of application No. PCT/KR2025/011343, filed on Jul. 30, 2025.

(30) Foreign Application Priority Data
Dec. 3, 2024 (KR) 10-2024-0177808

(51) Int. Cl. G06F 3/06

(52) U.S. Cl. CPC G06F 3/0655; G06F 3/061; G06F 3/0679

(57) ABSTRACT

A method for operating an electronic device, the electronic device including a plurality of neural processing unit (NPU) devices and an NPU management device configured to control the plurality of NPU devices, includes: determining whether input/output data of an artificial neural network application is shared by at least one NPU device configured to perform the artificial neural network application; determining whether a shared memory is available, wherein the NPU management device is further configured to control the shared memory; and storing the input/output data in the shared memory in a case that the input/output data of the artificial neural network application is shared by the at least one NPU device and that the shared memory is available, wherein the shared memory is shared by at least one neural network accelerator of the at least one NPU device.

### CROSS-REFERENCE TO RELATED APPLICATIONS

This application is a by-pass continuation application of International Application No. PCT/KR 2025/011343, filed on Jul. 30, 2025, which is based on and claims priority to Korean Patent Application No. 10-2024-0177808, filed on Dec. 3, 2024, in the Korean Intellectual Property Office, the disclosures of which are incorporated by reference herein their entireties.

### BACKGROUND

### 1. Field

The disclosure relates to a method and a device configured to control multiple neural processing units (NPUs) in the device.

### 2. Description of Related Art

An artificial neural network model is modeled by connecting nodes, which imitate human neurons, in a layer (or hierarchy) structure. The artificial neural network model may include a deep neural network (DNN), a convolutional neural network (CNN), and a recurrent neural network (RNN). The artificial neural network model is utilized to enhance inference accuracy in tasks based on images, videos, and natural language. Each artificial neural network model may increase the inference efficiency by operating on a neural processing unit (NPU) having an optimized structure.

When an electronic device includes a single NPU, there may be insufficient resources to process a plurality of artificial neural network applications. In contrast, when the electronic device includes a plurality of NPU devices, computations may be accelerated by utilizing the plurality of NPU devices, but there is a need for a method for controlling and managing the plurality of NPU devices.

### SUMMARY

The disclosure provides a method and a device for controlling multiple NPUs in the device. Specifically, one or more embodiments of the disclosure relate to a multi-NPU control method and device for allocating an artificial neural network application to a specialized NPU device through an NPU management device, managing NPU resources, and managing input/output data common to at least one NPU device through shared memory.

According to an aspect of the disclosure, an electronic device includes: a plurality of neural processing unit (NPU) devices; an NPU management device configured to control the plurality of NPU devices; at least one memory storing at least one instruction; and at least one processor configured to execute the at least one instruction and electronically or operatively connected with the plurality of NPU devices, the NPU management device, and the at least one memory; wherein the at least one processor is configured to: determine whether input/output data of an artificial neural network application is shared by at least one NPU device configured to perform the artificial neural network application; determine whether a shared memory is available, wherein the NPU management device is further configured to control the shared memory; and store the input/output data in the shared memory in a case that the input/output data of the artificial neural network application is shared by the at least one NPU device and that the shared memory is available, and wherein the shared memory is shared by at least one neural network accelerator of the at least one NPU device.

According to an aspect of the disclosure, a method for operating an electronic device, the electronic device including a plurality of neural processing unit (NPU) devices and an NPU management device configured to control the plurality of NPU devices, includes:
determining whether input/output data of an artificial neural network application is shared by at least one NPU device configured to perform the artificial neural network application;
determining whether a shared memory is available, wherein the NPU management device is further configured to control the shared memory; and storing the input/output data in the shared memory in a case that the input/output data of the artificial neural network application is shared by the at least one NPU device and that the shared memory is available, wherein the shared memory is shared by at least one neural network accelerator of the at least one NPU device.

Further, according to an embodiment of the disclosure, there may be included a computer-readable recording medium recording a program for performing the method.

According to one or more embodiments of the disclosure, artificial neural network applications may be accelerated in a multi-NPU environment, and by allocating an artificial neural network application to a specialized NPU device through an NPU management device, artificial neural network applications may operate efficiently.

Further, according to one or more embodiments of the disclosure, memory resources may be effectively managed in a multi-NPU environment by managing input/output data shared by a plurality of artificial neural network applications through shared memory.

Further, according to one or more embodiments of the disclosure, NPU resources may be efficiently managed in a multi-NPU environment and artificial neural network applications with long operation times may also be efficiently performed using the plurality of NPU resources by monitoring the state of NPU devices through the resource manager of the NPU management device and controlling idle NPU devices to perform predetermined operations in a case that there are operating artificial neural network applications.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an NPU management device, an NPU device, and shared memory according to one or more embodiments of the disclosure;

FIG. 2 illustrates an electronic device according to an embodiment of the disclosure;

FIGS. 3A and 3B are flowcharts illustrating an operation method of an electronic device that performs an artificial neural network application operation with it allocated to an NPU device according to an embodiment of the disclosure; and

FIGS. 4A and 4B are flowcharts illustrating an operation method of an electronic device that controls some operations to be performed using a common neural network accelerator of another NPU device in a case that there is an artificial neural network application operating in an NPU device according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

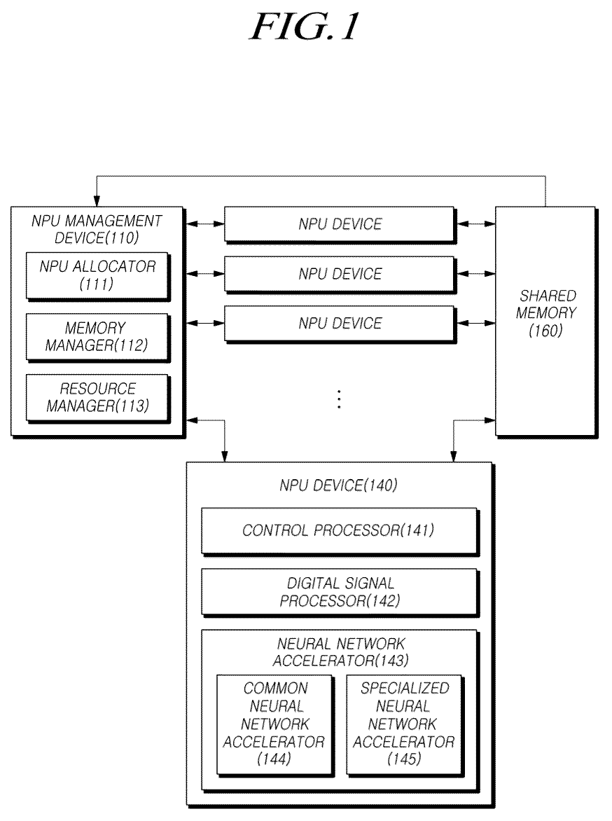

FIG. 1 illustrates an NPU management device, an NPU device, and shared memory according to one or more embodiments of the disclosure.

According to one or more embodiments, an NPU management device 110, a plurality of NPU devices 140, and shared memory 160 may be included in or connected to an electronic device (or edge device). The electronic device may include a smart TV, a media player, a set-top box, a terminal for digital broadcasting, a laptop, a PC, a smartphone, a tablet PC, a mobile phone, a personal digital assistant (PDA), a micro server, a navigation system, a kiosk, a home appliance, and other mobile or non-mobile computing devices, but the disclosure is not limited thereto.

According to one or more embodiments, the NPU device 140 may be a processor designed to perform operations for an artificial neural network. An artificial neural network may refer to a network of artificial neurons that, upon receiving a plurality of inputs or stimuli, multiply each by a weight, sum them, add a bias, transform the result through an activation function, and transfer the same. Such a trained artificial neural network may be used to output inference results from input data. The NPU device 140 may include a control processor 141, a digital signal processor 142, and a neural network accelerator 143. The control processor 141 may control the digital signal processor 142 and the neural network accelerator 143. The digital signal processor 142 may perform computations that may not be accelerated by the neural network accelerator 143. The computations that may not be accelerated by the neural network accelerator 143 may include element-wise multiplication operations and normalization operations, but the disclosure is not limited thereto.

According to one or more embodiments, the neural network accelerator 143 may include a common neural network accelerator 144 and a specialized neural network accelerator 145. The common neural network accelerator 144 may accelerate computations commonly used in the artificial neural network. The artificial neural network may include a deep neural network (DNN), a convolutional neural network (CNN), a recurrent neural network (RNN), and a large language model (LLM), but the disclosure is not limited thereto. Computations commonly used in an artificial neural network may include activation operations and reshape operations, but the disclosure is not limited thereto. The specialized neural network accelerator 145 may accelerate neural network computations specialized for each artificial neural network model. For example, the specialized neural network accelerator 145 may accelerate convolution operations of a CNN, long short-term memory (LSTM) operations of an RNN, and gated recurrent unit (GRU) operations, but the disclosure is not limited thereto.

According to one or more embodiments, the shared memory 160 may store input/output data shared by at least one NPU device.

According to one or more embodiments, the NPU management device 110 may control and manage a plurality of NPU devices 140. The NPU management device 110 may include an NPU allocator 111, a memory manager 112, and a resource manager 113.

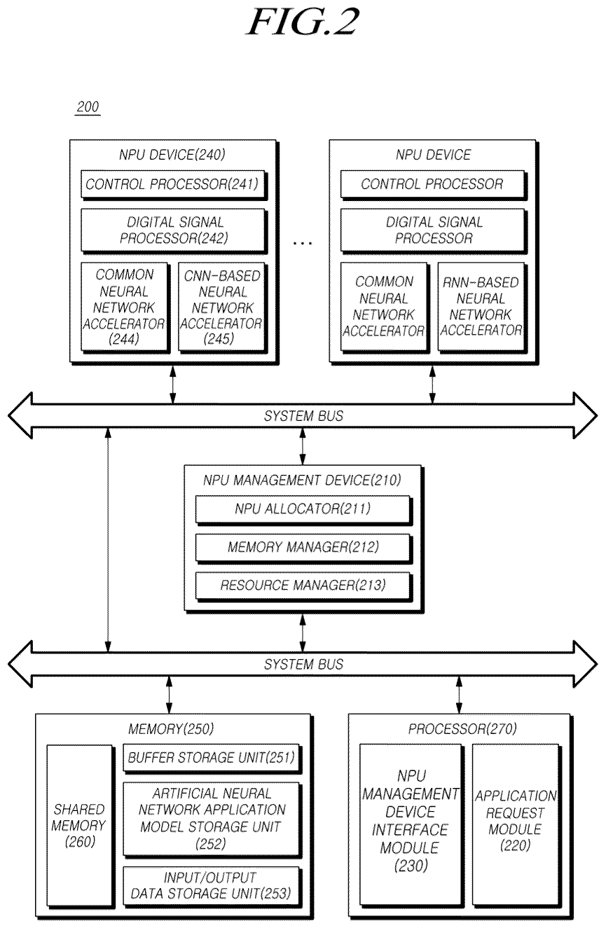

According to one or more embodiments, the NPU management device 110 may allocate an artificial neural network application program (hereinafter, an artificial neural network application) requested by an application requester to the NPU device through the NPU allocator 111, thereby controlling the allocated NPU device to perform the artificial neural network application. The operation of the application requester is described below with reference to FIG. 2.

According to one or more embodiments, the artificial neural network application may include, but is not limited to, an image quality enhancement application, a genre recognition application of a screen, a face recognition application, a scene recognition application, a user interest area recognition application, an object split application of a screen, an image quality improvement application, a sound quality enhancement application, an individual object separation application of a sound, a speaker recognition application, and a chatbot application that is based on a large language model (LLM).

According to one or more embodiments, the memory manager 112 may manage the shared memory 160 that stores input/output data shared by at least one NPU device.

According to one or more embodiments, the resource manager 113 may manage models of artificial neural network applications associated with respective NPU devices and monitor the state of respective NPU devices. The resource manager 113 may maintain and manage a list of NPU devices corresponding to types of artificial neural networks. For example, the resource manager 113 may associate a CNN artificial neural network with an NPU device specialized to accelerate convolution operations of the CNN. The resource manager 113 may monitor the state of the digital signal processor 142, the common neural network accelerator 144, and the specialized neural network accelerator 145 of the NPU device 140. The state may include a working state and a standby state but is not limited thereto.

According to one or more embodiments, the NPU allocator 111 may allocate an NPU device capable of executing a requested artificial neural network application from among a plurality of NPU devices based on the model of the artificial neural network application through the resource manager 113. The NPU allocator 111 may control the allocated NPU device to operate the artificial neural network application.

FIG. 2 illustrates an electronic device according to an embodiment of the disclosure.

Referring to FIG. 2, an electronic device 200 may include an NPU management device 210, a plurality of NPU devices 240, memory 250, and a processor 270. The NPU management device 210 and the plurality of NPU devices 240 of FIG. 2 may correspond to the NPU management device 110 and the plurality of NPU devices 140 of FIG. 1, respectively, and thus, redundant descriptions may be omitted. The NPU management device 210, the plurality of NPU devices 240, the memory 250, and the processor 270 may be electrically connected by a system bus. The electronic device 200 may include additional components other than the illustrated components, or may omit at least one of the illustrated components.

According to an embodiment, the memory 250 is a storage medium used by the electronic device 200 and may store data, such as at least one instruction or configuration information corresponding to at least one program. The program may include an operating system (OS) program and various application programs. According to an embodiment, the memory 250 may store at least one instruction including an application request module 220 and an NPU management device interface module 230.

According to an embodiment, the memory 250 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an embodiment, the memory 250 may include a shared memory 260 area that stores input/output data shared by at least one NPU device. The memory 250 may include memory areas respectively corresponding to a buffer storage unit 251, an artificial neural network application model storage unit 252, and an input/output data storage unit 253. The buffer storage unit 251 may store a buffer necessary for the execution of neural network accelerators 244, 245, a digital signal processor 242, and a control processor 241 of each NPU devices 240. The artificial neural network application model storage unit 252 may store a model of the artificial neural network application. For example, in a case that the artificial neural network application model is a CNN model, the artificial neural network application model storage unit 252 may store information indicating the CNN model and various metadata (e.g., weights of the neural network model) corresponding to the CNN model. The input/output data storage unit 253 may store input/output data of the artificial neural network application.

According to an embodiment, the processor 270 may control at least one other component of the electronic device 200 and/or execute computation or data processing regarding communication by executing at least one instruction stored in the memory 250. For example, the processor 270 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

According to an embodiment, the processor 270 may execute the NPU management device interface module 230 to store the buffer necessary for the execution of neural network accelerators 244, 245, the digital signal processor 242, and the control processor 241 of each NPU device in the buffer storage unit 251 of the memory 250. According to an embodiment, the processor 270 may store the buffer during a system loading step of the electronic device 200, but the disclosure is not limited thereto.

According to an embodiment, the processor 270 may execute the application request module 220 to request the operation of the artificial neural network application from the NPU management device interface module 230. The artificial neural network application may include, but is not limited to, an image quality enhancement application, a genre recognition application of a screen, a face recognition application, a scene recognition application, a user interest area recognition application, an object split application of a screen, an image quality improvement application, a sound quality enhancement application, an individual object separation application of a sound, a speaker recognition application, and a chatbot application based on a large language model (LLM).

According to an embodiment, the processor 270 may execute the NPU management device interface module 230 to store the model of the artificial neural network application and the input/output data of the artificial neural network application in the artificial neural network application model storage unit 252 and the input/output data storage unit 253 of the memory 250, respectively, in response to (or based on) the request for the operation of the artificial neural network application from the application request module 220.

According to an embodiment, the processor 270 may execute the NPU management device interface module 230 to determine whether the input/output data of the artificial neural network application is shared by at least one NPU device and identify whether the shared memory 260 is available wherein the NPU management device 210 (in particular, the memory manager 212) is further configured to control the shared memory 260. The NPU management device interface module 230 may store the input/output data in the shared memory 260 in a case that the input/output data of the artificial neural network application is shared by at least one NPU device and the shared memory 260 is available. The shared input/output data may include a frame of an image quality application and a sound of a sound application, but the disclosure is not limited thereto. The input/output data stored in the shared memory 260 may be shared for reading or writing among at least one NPU device configured to perform the artificial neural network application.

According to an embodiment, the processor 270 may execute the NPU management device interface module 230 to provide the model of the artificial neural network application to the NPU management device 210.

According to an embodiment, the NPU management device 210 may be implemented as a software module (e.g., software codes) and be executed by the processor 270 or executed by a separate processor. The separate processor may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

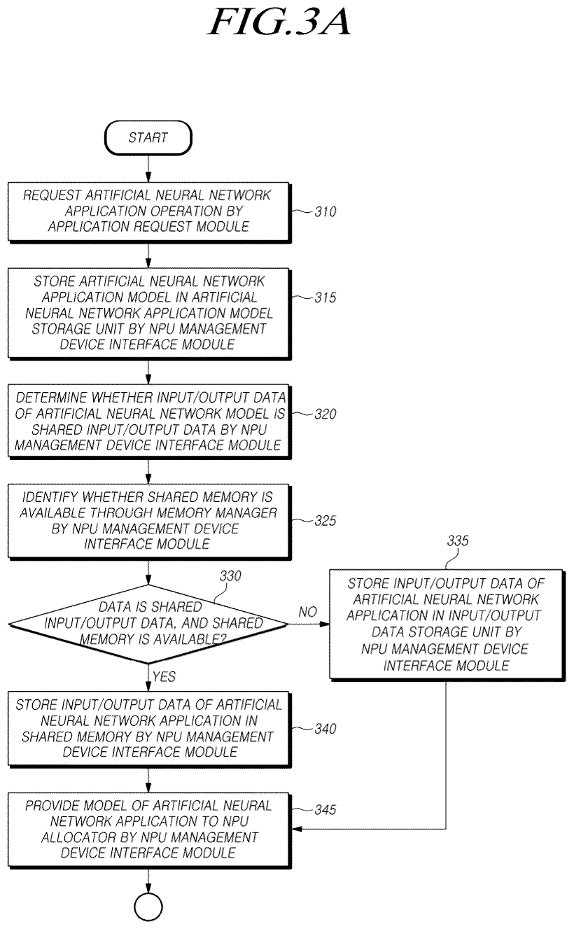

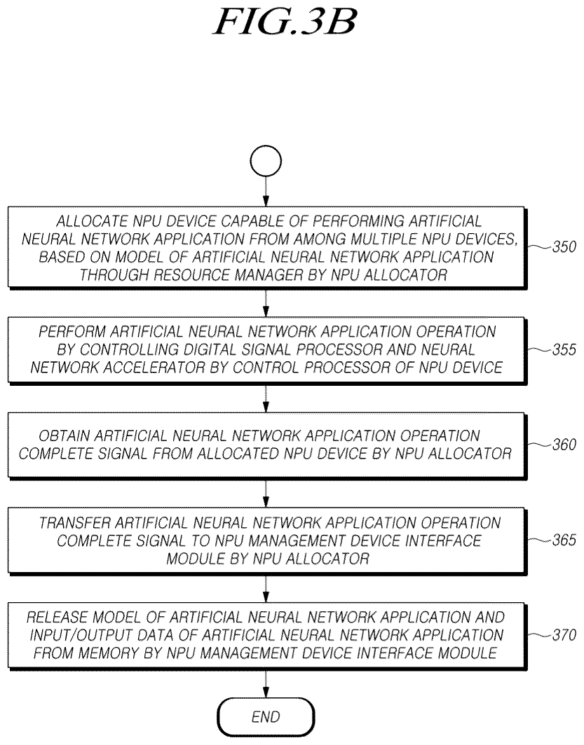

According to an embodiment, the NPU allocator 211 may allocate an NPU device to perform the requested artificial neural network application from among the plurality of NPU devices based on the model of the artificial neural network application through the resource manager 213. For example, in a case that a CNN-based artificial neural network application is requested to operate, the NPU allocator 211 may obtain information about an NPU device specialized to accelerate convolution operations of the CNN and state information indicating that the specialized neural network accelerator of the NPU device is in a standby state through the resource manager 213, and may allocate the application to the NPU device specialized to accelerate convolution operations of the CNN. The NPU allocator 211 may control the allocated NPU device to operate the artificial neural network application. An operation method of an electronic device that performs an artificial neural network application operation with it allocated to an NPU device is described in detail with reference to FIGS. 3A and 3B.

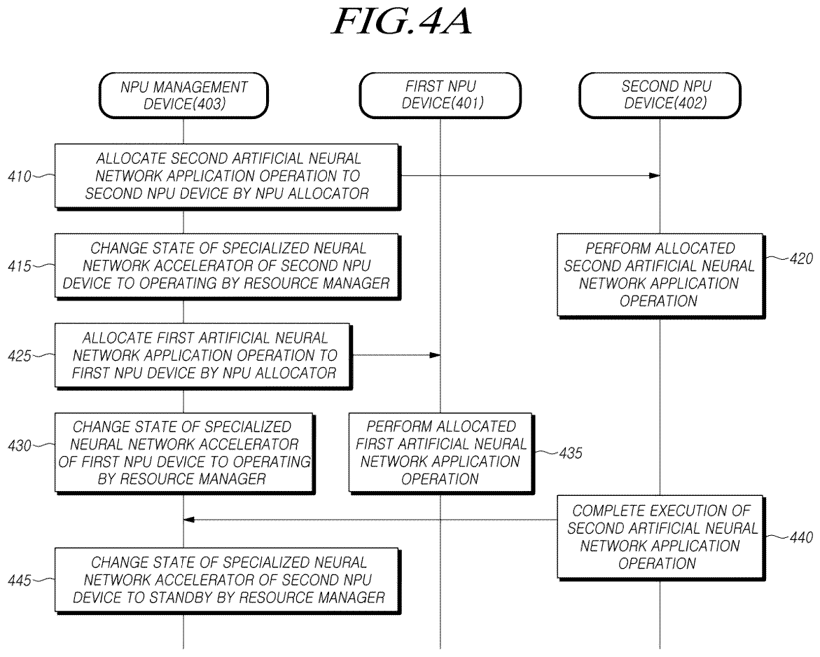

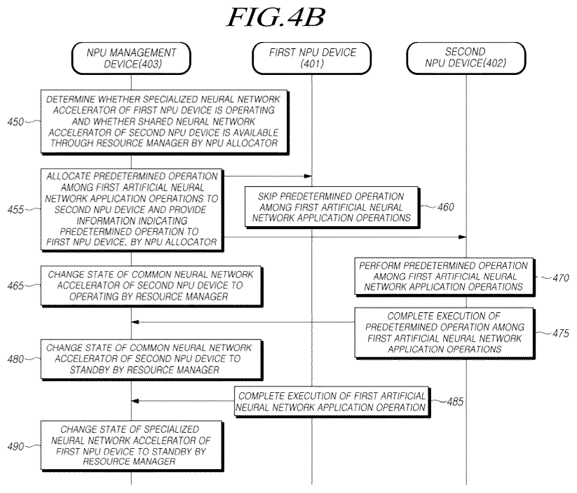

According to an embodiment, the NPU allocator 211 may allocate a predetermined operation of a first artificial neural network application to a second NPU device in a case that a first NPU device is operating a first artificial neural network application through the resource manager 213, and the common neural network accelerator of the second NPU device is in a standby state. According to this embodiment, by monitoring the state of the NPU device through the resource manager 213 and, in a case that there is an operating artificial neural network application, controlling an idle NPU device to perform some operations, NPU resources may be efficiently managed in a multi-NPU environment, and artificial neural network applications with long operation times may also be efficiently performed using the plurality of NPU resources. The operation method of the electronic device according to an embodiment is described in detail with reference to FIGS. 4A and 4B.

According to an embodiment, the NPU allocator 211 may obtain an artificial neural network application operation complete signal from the allocated NPU device. The NPU allocator 211 may transfer the artificial neural network application operation complete signal to the NPU management device interface module 230. The processor 270 may execute the NPU management device interface module 230 to release the model of the artificial neural network application and the input/output data of the artificial neural network application from the memory 250.

FIGS. 3A and 3B are flowcharts illustrating an operation method of an electronic device that performs an artificial neural network application operation with it allocated to an NPU device according to an embodiment of the disclosure.

The electronic device of FIGS. 3A and 3B may correspond to the electronic device 200 of FIG. 2. In the operation of the electronic device described in connection with FIGS. 3A and 3B, portions overlapping those described in connection with FIG. 2 may be omitted. Some operations illustrated in FIGS. 3A and 3B may be omitted, and other operations in FIGS. 3A and 3B may be added.

According to an embodiment, in operation 310, the electronic device 200 may request an artificial neural network application operation by the application request module 220.

According to an embodiment, in operation 315, the electronic device 200 may store the model of the artificial neural network application in the memory 250 in response to (or based on) the artificial neural network application operation request by the NPU management device interface module 230.

According to an embodiment, in operation 320, the electronic device 200 may determine whether the input/output data of the artificial neural network model is shared input/output data by the NPU management device interface module 230.

According to an embodiment, in operation 325, the electronic device 200 may identify whether the shared memory is available through the memory manager 212 by the NPU management device interface module 230.

According to an embodiment, in operation 330, in a case that it is determined that the input/output data is shared input/output data and shared memory is available, the electronic device 200 may perform operation 340 by the NPU management device interface module 230, and otherwise may perform operation 335.

According to an embodiment, in operation 335, the electronic device 200 may store the input/output data of the artificial neural network application in the input/output data storage unit 253 by the NPU management device interface module 230.

According to an embodiment, in operation 340, the electronic device 200 may store the input/output data of the artificial neural network application in the shared memory 260 by the NPU management device interface module 230.

According to an embodiment, in operation 345, the electronic device 200 may provide the model of the artificial neural network application to the NPU allocator 211 by the NPU management device interface module 230.

According to an embodiment, in operation 350, the electronic device 200 may allocate an NPU device capable of performing the artificial neural network application among the plurality of NPU devices based on the model of the artificial neural network application through the resource manager 213 by the NPU allocator 211.

According to an embodiment, in operation 355, the electronic device 200 may perform the artificial neural network application operation by controlling the digital signal processor 242 and the neural network accelerators 244, 245 by the control processor 241 of the NPU device.

According to an embodiment, in operation 360, the electronic device 200 may obtain an artificial neural network application operation complete signal from the allocated NPU device by the NPU allocator 211.

According to an embodiment, in operation 365, the electronic device 200 may transmit the artificial neural network application operation complete signal to the NPU management device interface module 230 by the NPU allocator 211.

According to an embodiment, in operation 370, the electronic device 200 may release the model of the artificial neural network application and the input/output data of the artificial neural network application from the memory 250 by the NPU management device interface module 230.

FIGS. 4A and 4B are flowcharts illustrating an operation method of an electronic device that controls some operations to be performed using a common neural network accelerator of another NPU device in a case that there is an artificial neural network application operating in an NPU device according to an embodiment of the disclosure.

The electronic device of FIGS. 4A and 4B may correspond to the electronic device 200 of FIG. 2. In the operation of the electronic device described in connection with FIGS. 4A and 4B, portions overlapping those described in connection with FIG. 2 may be omitted. Some operations illustrated in FIGS. 4A and 4B may be omitted, and other operations in FIGS. 4A and 4B may be added.

In an embodiment with reference to FIGS. 4A and 4B, the first artificial neural network application may be a CNN-based artificial neural network application, and the second artificial neural network application may be an RNN-based artificial neural network application. The first artificial neural network application may include computations that operate through the common neural network accelerator. The resource manager 213 may associate the CNN-based artificial neural network application with the first NPU device 401 and the RNN-based artificial neural network application with the second NPU device 402. The resource manager 213 may monitor the state of each of the digital signal processor, common neural network accelerator, and specialized neural network accelerator of the first NPU device 401 and the second NPU device 402. The state may include a working state and a standby state but is not limited thereto. Referring to FIGS. 4A and 4B, prior to performing operation 410, the state of the digital signal processor, the common neural network accelerator, and the specialized neural network accelerator of the first NPU device 401 and the second NPU device 402 may all be in the standby state.

According to an embodiment, referring to FIGS. 3A and 3B, as described above, the NPU allocator of the NPU management device 403 may be provided with the model of the second artificial neural network application from the NPU management device interface module.

Referring to FIG. 4A, in operation 410 according to an embodiment, the NPU allocator of the NPU management device 403 may allocate a second artificial neural network application operation to the second NPU device 402 through the resource manager.

According to an embodiment, in operation 415, the resource manager of the NPU management device 403 may change the state of the specialized neural network accelerator of the second NPU device 402 to an operating state.

According to an embodiment, in operation 420, the specialized neural network accelerator of the second NPU device 402 may perform the allocated second artificial neural network application operation.

According to an embodiment, the NPU allocator of the NPU management device 403 may be provided with the model of the first artificial neural network application from the NPU management device interface module.

According to an embodiment, in operation 425, the NPU allocator of the NPU management device 403 may allocate the first artificial neural network application operation to the first NPU device 401 through the resource manager.

According to an embodiment, in operation 430, the resource manager of the NPU management device 403 may change the state of the specialized neural network accelerator of the first NPU device 401 to an operating state.

According to an embodiment, in operation 435, the specialized neural network accelerator of the first NPU device 401 may perform the allocated first artificial neural network application operation.

According to an embodiment, in operation 440, the NPU allocator of the NPU management device 403 may obtain a completion signal of the second artificial neural network application operation from the second NPU device 402.

According to an embodiment, in operation 445, the resource manager of the NPU management device 403 may change the state of the specialized neural network accelerator of the second NPU device 402 to a standby state.

Referring to FIG. 4B, in operation 450 according to an embodiment, the NPU allocator of the NPU management device 403 may determine whether the first NPU device 401 is operating the first artificial neural network application and whether the common neural network accelerator of the second NPU device 402 is available through the resource manager. In other words, the NPU allocator of the NPU management device 403 may determine whether the state of the common neural network accelerator of the second NPU device 402 is in a standby state through the resource manager.

If the state of the common neural network accelerator of the second NPU device 402 is in a standby state, in operation 455 according to an embodiment, the NPU allocator of the NPU management device 403 may determine a predetermined operation that may be performed through the common neural network accelerator among the first artificial neural network application operations that have not yet been performed, allocate the predetermined operation to the common neural network accelerator of the second NPU device 402, and provide information indicating the predetermined operation to the first NPU device 401. The predetermined operation may be a computation that is performed through the common neural network accelerator among the operations of the first artificial neural network application.

In operation 460 according to an embodiment, the first NPU device 401 may skip the execution of the predetermined operation in the first artificial neural network application.

According to an embodiment, in operation 465, the resource manager of the NPU management device 403 may change the state of the common neural network accelerator of the second NPU device 402 to an operating state.

According to an embodiment, in operation 470, the common neural network accelerator of the second NPU device 402 may perform the allocated predetermined operation of the first artificial neural network application. In this case, the shared memory 260 described above with reference to FIG. 2 may be shared by the first NPU device 401 and the second NPU device 402 configured to perform the first artificial neural network application. Specifically, the shared memory 260 may be shared by the specialized neural network accelerator of the first NPU device 401 and the common neural network accelerator of the second NPU device 402.

According to an embodiment, in operation 475, the NPU allocator of the NPU management device 403 may obtain a completion signal of the predetermined operation of the first artificial neural network application from the second NPU device 402.

According to an embodiment, in operation 480, the resource manager of the NPU management device 403 may change the state of the common neural network accelerator of the second NPU device 402 to a standby state.

According to an embodiment, in operation 485, the NPU allocator of the NPU management device 403 may obtain a completion signal of the first artificial neural network application operation from the first NPU device 401.

According to an embodiment, in operation 490, the resource manager of the NPU management device 403 may change the state of the specialized neural network accelerator of the first NPU device 401 to a standby state.

According to an embodiment of the disclosure, an electronic device may comprise a plurality of neural processing unit (NPU) devices, an NPU management device configured to control the plurality of NPU devices, at least one memory storing at least one instruction, at least one processor configured to execute the at least one instruction and electronically or operatively connected with the plurality of NPU devices, the NPU management device, and the at least one memory.

The at least one processor may be configured to determine whether input/output data of an artificial neural network application is shared by at least one NPU, determine whether a shared memory is available through the NPU management device, and store the input/output data in the shared memory in a case that the input/output data of the artificial neural network application is shared by the at least one NPU device and the shared memory is available. The shared memory may be shared by at least one neural network accelerator of the at least one NPU device configured to perform the artificial neural network application.

According to an embodiment, the NPU management device may be configured to manage the shared memory storing the input/output data shared by the at least one NPU device, manage a model of an artificial neural network application associated with each NPU device of the plurality of NPU devices and monitor a state of each NPU device, and allocate an NPU device capable of performing the artificial neural network application from among the plurality of NPU devices based on the model of the artificial neural network application.

According to an embodiment, the at least one processor may be configured to store the model of the artificial neural network application and the input/output data of the artificial neural network application in the at least one memory in response to (or based on) an artificial neural network application operation request, and provide the model of the artificial neural network application to the NPU management device. The NPU management device may be configured to allocate an NPU device to perform the artificial neural network application among the plurality of NPU devices based on the model of the artificial neural network application, and control the allocated NPU device to operate the artificial neural network application.

According to an embodiment, the shared input/output data may include a frame of an image quality application and a sound of a sound application.

According to an embodiment, the NPU management device may be configured to obtain an artificial neural network application operation complete signal from the allocated NPU device, and transfer the artificial neural network application operation completion signal to the at least one processor. The at least one processor may be configured to release the model of the artificial neural network and the input/output data of the artificial neural network application from the at least one memory.

According to an embodiment, each NPU device may include a neural network accelerator, a digital signal processor configured to perform a computation that may not be accelerated by the neural network accelerator, and a control processor controlling the digital signal processor and the neural network accelerator. The neural network accelerator may include a common neural network accelerator configured to perform computation acceleration commonly used in an artificial neural network and a specialized neural network accelerator configured to perform neural network computation acceleration specialized for each artificial neural network model.

According to an embodiment, in a case that a first NPU device is operating a first artificial neural network application and a common neural network accelerator of a second NPU device is in a standby state, the NPU management device may be configured to allocate a predetermined operation of the first artificial neural network application to the common neural network accelerator of the second NPU device.

According to an embodiment, the at least one processor may be configured to allocate, in the at least one memory, a buffer necessary for operating the neural network accelerator, the digital signal processor, and the control processor of each NPU device.

According to an embodiment, the artificial neural network application may include at least one of an image quality enhancement application, a genre recognition application of a screen, a face recognition application, a scene recognition application, a user interest area recognition application, an object split application of a screen, an image quality improvement application, a sound quality enhancement application, an individual sound separation application of a sound, a speaker recognition application, or a chatbot application that is based on a large language model (LLM).

Further, according to an embodiment of the disclosure, in a method for operating an electronic device, the electronic device may include a plurality of neural processing unit (NPU) devices and an NPU management device configured to control the plurality of NPU devices. The method may comprise determining whether input/output data of an artificial neural network application is shared by at least one NPU device, determining whether a shared memory is available, wherein the NPU management device is further configured to control the shared memory, and storing the input/output data in the shared memory in a case that the input/output data of the artificial neural network application is shared by the at least one NPU device and the shared memory is available. The shared memory may be shared by at least one neural network accelerator of the at least one NPU device configured to perform the artificial neural network application.

According to an embodiment, the NPU management device may include an NPU allocator, a memory manager, and a resource manager. The method may further comprise managing, by the memory manager, shared memory storing input/output data shared by at least one NPU device, managing, by the resource manager, a model of an artificial neural network application associated with each NPU device and monitoring a state of the each NPU device, and allocating, by the NPU allocator through the resource manager, an NPU device capable of performing the artificial neural network application from among the plurality of NPU devices based on the model of the artificial neural network application.

According to an embodiment, the method may further comprise storing a model of the artificial neural network application and the input/output data of the artificial neural network application in at least one memory in response to (or based on) an artificial neural network application operation request, providing the model of the artificial neural network application to the NPU management device, allocating, by the NPU management device, an NPU device to perform the artificial neural network application among the plurality of NPU devices based on the model of the artificial neural network application, and controlling, by the NPU management device, the allocated NPU device to operate the artificial neural network application.

According to an embodiment, the shared input/output data may include a frame of an image quality application and a sound of a sound application.

According to an embodiment, the method may further comprise obtaining, by the NPU allocator, an artificial neural network application operation complete signal from the allocated NPU device, and releasing the model of the artificial neural network and the input/output data of the artificial neural network application from the at least one memory in response to (or based on) obtaining the artificial neural network application operation complete signal.

According to an embodiment, each NPU device may include a neural network accelerator, a digital signal processor configured to perform a computation that may not be accelerated by the neural network accelerator, and a control processor configured to control the digital signal processor and the neural network accelerator. The neural network accelerator may include a common neural network accelerator configured to perform computation acceleration commonly used in an artificial neural network and a specialized neural network accelerator configured to perform neural network computation acceleration specialized for each artificial neural network model.

According to an embodiment, the method may further comprise, in a case that a first NPU device is operating a first artificial neural network application and a common neural network accelerator of a second NPU device is in a standby state, allocating, by the NPU allocator, a predetermined operation of the first artificial neural network application to the common neural network accelerator of the second NPU device.

According to an embodiment, the method may further comprise allocating, in the at least one memory, a buffer necessary for operating the neural network accelerator, the digital signal processor, and the control processor of the each NPU device.

According to an embodiment, the artificial neural network application may include at least one of an image quality enhancement application, a genre recognition application of a screen, a face recognition application, a scene recognition application, a user interest area recognition application, an object split application of a screen, an image quality improvement application, a sound quality enhancement application, an individual object separation application of a sound, a speaker recognition application, or a chatbot application that is based on a large language model (LLM).

The electronic device according to one or more embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that one or more embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in one or more embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 200 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. Some of the plurality of entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a plurality of neural processing unit (NPU) devices;
an NPU management device configured to control the plurality of NPU devices;
at least one memory storing at least one instruction; and
at least one processor configured to execute the at least one instruction and electronically or operatively connected with the plurality of NPU devices, the NPU management device, and the at least one memory;
wherein the at least one processor is configured to:
determine whether input/output data of an artificial neural network application is shared by at least one NPU device configured to perform the artificial neural network application;
determine whether a shared memory is available, wherein the NPU management device is further configured to control the shared memory; and
store the input/output data in the shared memory in a case that the input/output data of the artificial neural network application is shared by the at least one NPU device and that the shared memory is available, and
wherein the shared memory is shared by at least one neural network accelerator of the at least one NPU device.

2. The electronic device of claim 1, wherein the NPU management device further is configured to:
manage the shared memory storing the input/output data shared by the at least one NPU device;
manage a model of the artificial neural network application associated with each NPU device of the plurality of NPU devices and monitor a state of the each NPU device; and
allocate an NPU device capable of performing the artificial neural network application from among the plurality of NPU devices based on the model of the artificial neural network application.

3. The electronic device of claim 2, wherein the at least one processor is further configured to:
store the model of the artificial neural network application and the input/output data of the artificial neural network application in the at least one memory based on an artificial neural network application operation request; and
provide the model of the artificial neural network application to the NPU management device, and
wherein the NPU management device is further configured to:
allocate an NPU device to perform the artificial neural network application among the plurality of NPU devices based on the model of the artificial neural network application; and
control the allocated NPU device to operate the artificial neural network application.

4. The electronic device of claim 1, wherein the shared input/output data comprises a frame of an image quality application and a sound of a sound application.

5. The electronic device of claim 3, wherein the NPU management device is further configured to:
obtain an artificial neural network application operation completion signal from the allocated NPU device; and
transfer the artificial neural network application operation completion signal to the at least one processor, and
wherein the at least one processor is further configured to release, from the at least one memory, the model of the artificial neural network application and the input/output data of the artificial neural network application.

6. The electronic device of claim 2, wherein each NPU device comprises a neural network accelerator, a digital signal processor configured to perform a computation that may not be accelerated by the neural network accelerator, and a control processor configured to control the digital signal processor and the neural network accelerator, and
wherein the neural network accelerator comprises a common neural network accelerator configured to perform computation acceleration commonly used in an artificial neural network and a specialized neural network accelerator configured to perform neural network computation acceleration specialized for each artificial neural network model.

7. The electronic device of claim 6, wherein, in a case that a first NPU device is operating a first artificial neural network application and a common neural network accelerator of a second NPU device is in a standby state, the NPU management device is further configured to allocate a predetermined operation of the first artificial neural network application to the common neural network accelerator of the second NPU device.

8. The electronic device of claim 6, wherein the at least one processor is further configured to allocate, in the at least one memory, a buffer necessary for operating the neural network accelerator, the digital signal processor, and the control processor of each NPU device.

9. The electronic device of claim 1, wherein the artificial neural network application comprises at least one of an image quality enhancement application, a genre recognition application of a screen, a face recognition application, a scene recognition application, a user interest area recognition application, an object split application of a screen, an image quality improvement application, a sound quality enhancement application, an individual object separation application of a sound, a speaker recognition application, or a chatbot application that is based on a large language model (LLM).

10. A method for operating an electronic device, the electronic device including a plurality of neural processing unit (NPU) devices and an NPU management device configured to control the plurality of NPU devices, the method comprising:
determining whether input/output data of an artificial neural network application is shared by at least one NPU device configured to perform the artificial neural network application;
determining whether a shared memory is available, wherein the NPU management device is further configured to control the shared memory; and
storing the input/output data in the shared memory in a case that the input/output data of the artificial neural network application is shared by the at least one NPU device and that the shared memory is available,
wherein the shared memory is shared by at least one neural network accelerator of the at least one NPU device.

11. The method of claim 10, wherein the NPU management device includes an NPU allocator, a memory manager, and a resource manager, and wherein the method further comprises:
managing, by the memory manager, the shared memory storing the input/output data shared by at least one NPU device;
managing, by the resource manager, a model of an artificial neural network application associated with each NPU device of the plurality of NPU devices and monitoring a state of the each NPU device; and
allocating, by the NPU allocator through the resource manager, an NPU device capable of performing the artificial neural network application from among the plurality of NPU devices based on the model of the artificial neural network application.

12. The method of claim 11, further comprising:
storing the model of the artificial neural network application and the input/output data of the artificial neural network application in at least one memory based on an artificial neural network application operation request;
providing the model of the artificial neural network application to the NPU management device;
allocating, by the NPU management device, an NPU device to perform the artificial neural network application among the plurality of NPU devices based on the model of the artificial neural network application; and
controlling, by the NPU management device, the allocated NPU device to operate the artificial neural network application.

13. The method of claim 10, wherein the shared input/output data includes a frame of an image quality application and a sound of a sound application.

14. The method of claim 12, further comprising:
obtaining, by the NPU allocator, an artificial neural network application operation complete signal from the allocated NPU device; and
releasing the model of the artificial neural network application and the input/output data of the artificial neural network application from the at least one memory based on obtaining the artificial neural network application operation complete signal.

15. The method of claim 11, wherein each NPU device includes a neural network accelerator, a digital signal processor configured to perform a computation that may not be accelerated by the neural network accelerator, and a control processor configured to control the digital signal processor and the neural network accelerator, and
wherein the neural network accelerator includes a common neural network accelerator configured to perform computation acceleration commonly used in an artificial neural network and a specialized neural network accelerator configured to perform neural network computation acceleration specialized for each artificial neural network model.

16. The method of claim 15, further comprising, in a case that a first NPU device is operating a first artificial neural network application and a common neural network accelerator of a second NPU device is in a standby state, allocating, by the NPU allocator, a predetermined operation of the first artificial neural network application to the common neural network accelerator of the second NPU device.

17. The method of claim 15, further comprising allocating, in the at least one memory, a buffer necessary for operating the neural network accelerator, the digital signal processor, and the control processor of each NPU device.

18. The method of claim 10, wherein the artificial neural network application includes at least one of an image quality enhancement application, a genre recognition application of a screen, a face recognition application, a scene recognition application, a user interest area recognition application, an object split application of a screen, an image quality improvement application, a sound quality enhancement application, an individual object separation application of a sound, a speaker recognition application, or a chatbot application that is based on a large language model (LLM).
